(19) United States
(12) Patent Application Publication
(10) Pub. No.: US 2007/0032156 A1
(43) Pub. Date: Feb. 8, 2007

(54) Microfibrous non-woven chamois fabric having a high light fastness and process for its preparation

(76) Inventors: Paola Bianco, Amelia (TR) (IT); Luca Giancarlini, Terni (IT); Takafumi Hashimoto, Roma (IT)

Correspondence Address: Takafumi Hashimoto, 162-7 Karihara - Ritto, Shiga, JP

(21) Appl. No.: 11/472,489

(22) Filed: Jun. 21, 2006

(30) Foreign Application Priority Data
Jun. 24, 2005 (IT) MI2005A001202

(51) Int. Cl. B32B 5/02; B32B 27/12

(52) U.S. Cl. 442/340; 442/104; 442/131

(57) ABSTRACT

A non-woven chamois fabric is described consisting of a microfibrous portion and an elastomeric matrix, having high light fastness values.

Patent Application for the Industrial Invention entitled: “MICROFIBROUS NON-WOVEN CHAMOIS FABRIC HAVING A HIGH LIGHT FASTNESS AND PROCESS FOR ITS PREPARATION”

In the name of ALCANTARA S.p.A., an Italian company, registered at Via Mecenate, 86-20138 MILANO (Italy)

Inventors:

BIANCO Paola
GIANCARLINI Luca
HASHIMOTO Takafumi

*.*.*

The present invention relates to a microfibrous non-woven chamois fabric (hereinafter also microfibrous non-woven fabric) having a high light fastness. More specifically, the high level of colour fastness to light is obtained by using one or more UV stabilizers selected from benzotriazoles, triazines and benzophenones, at least one of the components belonging to the group of triazines.

It is known that the light fastness of microfibrous non-woven fabrics is generally not completely satisfactory for various particular applications, for example car upholstery. Attempts have been made in the past to enhance light fastness. For example the patent IT 1196456 describes the production of a microfibrous non-woven fabric prepared by using at least one UV stabilizer, selected from benzophenones and benzotriazoles, in the dyeing phase. This technology, however, has various limitations as its efficacy is limited to certain wave-lengths.

A microfibrous non-woven chamois fabric has now been found, which overcomes the drawbacks mentioned above as it has a high light fastness in the UV region.

In accordance with this, the present invention relates to a microfibrous non-woven chamois fabric comprising:
a) microfibres selected from polyester microfibres, said polyester being selected from polyethylene terephthalate, polytrimethylene terephthalate and polyethylene terephthalate dyeable with cationic dyes;
b) an elastomeric matrix, preferably selected from polyurethane, urea-polyurethane and relative blends;
c) UV stabilizer compositions, at least one of which has a maximum absorbance at wave-lengths from 270 to 285 nm.

In an embodiment, the polyester is dyed with a mix of dispersed dyes, of which at least one belonging to the group of anthraquinone dispersed dyes.

The UV stabilizer having a maximum absorbance at wavelengths from 270 to 285 nm is preferably selected from triazines and relative derivatives.

In one embodiment, the composition of the UV stabilizers consists of one or more UV stabilizers having a maximum absorbance at wave-lengths ranging from 270 to 285 nm.

According to a second embodiment, the composition of UV stabilizers consists of:
(i) one or more components having a maximum absorbance ranging from 270 to 285 nm;
(ii) one or more components selected from those belonging to the group of benzophenones and benzotriazoles and relative blends; the weight % of compound (i) with respect to the sum of (i)+(ii) preferably being at least 30%.

Typical examples of benzophenone derivatives are: 2,4-dihydroxybenzophenone, 2-hydroxy-4-methoxybenzophenone, 2-hydroxy-4-octyloxybenzophenone, 2-hydroxy-4-isooctyloxy benzophenone, 2-hydroxy-4-dodecyloxy benzophenone, 2,2′-dihydroxy-4-methoxybenzophenone, 2,2′,4,4′-tetrahydroxy benzophenone, 2,2-dihydroxy-4,4′-dimethoxybenzophenone, 2-hydroxy-4-methoxy-5-solfobenzophenone, 2-hydroxy-4-benzyloxybenzophenone.

Typical examples of benzotriazole derivatives are: 2-(2′hydroxyphenyl) benzotriazole, 2-(2′hydroxy-5-methylphenyl) benzotriazole, 2-(2′-hydroxy-3′,5 ′-di-t-butylphenyl)-5-chlorobenzotriazole, 2-(2′-hydroxy-3′sec-butyl-5 ′-methylphenyl) benzotriazole, 2-(2′-hydroxy-5′-octylphenyl) benzotriazole, 2-[2′-hydroxy-3′,5′-(di-t-butyl) phenyl] benzotriazole, 2-[2′-hydroxy-3′,5′-(di-t-amyl)phenyl] benzotriazole, 2-[2′-hydroxy-3′,5′-di-(α,α-dimethylbenzyl)phenyl] benzotriazole, 2-(3′-t-butyl-2′-hydroxy-5′-methylphenyl)-5-chlorobenzotriazole, 2-(2′-hydroxy-3′,5′-di-t-butyl)-5-chlorobenzotriazole, 2-(2′-hydroxy-5′-(1,1,3,3-tetramethylbutyl)phenyl) benzotriazole, 2-(2′-hydroxy-4′-octyloxyphenyl) benzotriazole, 2-(2′-hydroxy-3′,5′-di-t-amyl-phenyl) benzotriazole.

Typical examples of triazine derivatives are: 2,4,6(triphenyl)-1,3,5-triazine, 2,4,6-tri(2-hydroxy-4-octyloxyphenyl)-1,3,5-triazine, 2(2-hydroxy-4-hexyloxy-phenyl)-4,6-bisphenyl)-1,3,5-triazine, 2(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine,2,4-bis(2-hydroxy-4-propyl-oxyphenyl)-6-(2,4-dimethylphenyl)-1,3,5-triazine, 2-[2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis (2,4-dimephenyl]-4,6-bis(2,4-dimethyl )-1,3,5-triazine, 2-[2-hydroxy-4-(2-hydroxy-3-octyloxy propyloxyoctyloxypropyloxy)-phenyl]-4,6-bis(2,4-dimethyl)-1,3,5-triazine, 2-[4-(dodecyloxy/tridecyloxy-2-hydroxypropoxy)-2-hydroxyphenyl]4,6-bis(2,4-dimethylphenyl) -1,3,5-triazine, 2-[2-hydroxy-4-(2-hydroxy-3-dodecyloxypropoxy)-phenyl]-4,6-bis(2,4-dimethyl-phenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxy-phenyl)-4-(4-methoxyphenyl)-6-phenyl-1,3,5-triazine, 2-{2-hydroxy-4-[3-(2-ethylhexyl-1-oxy)-2-hydroxypropyloxy-phenyl}-4,6-bis-(2,4-dimethylphenyl)-1,3,5-triazine.

The non-woven fabric of the present invention shows a light fastness value higher than 3 (for details see the experimental part).

If microfibres consisting of polyethylene terephthalate alone are used, the product of the present invention has, upon reflectance spectrophotometric analysis in the colour space of CIELAB (1976), a luminosity value L lower than 35 (with a D65 illuminator and an observation angle of 100). This L value proved to be equal to 32 in the material described in the experimental part.

If microfibres consisting of polyethylene terephthalate and polyethylene terephthalate dyeable with cationic dyes are used, the product of the present invention has, upon reflectance spectrophotometric analysis in the colour space of CIELAB (1976), a luminosity value L ranging from 45 to 75 (with a D65 illuminator and an observation angle of 100). This L value proved to be equal to 55 in the material described in the experimental part.

The present invention also relates to a process for the preparation of microfibrous non-woven chamois fabric comprising the following steps:
(y1) preparation of unbleached, microfibrous non-woven chamois fabric;
(y2) dyeing of the unbleached fabric obtained in step (y1);
(y3) treatment of the dyed product obtained at the end of step (y2) with a composition of UV stabilizers, of which at least one has a maximum absorption at wave-lengths ranging from 270 to 285 nm.

Steps (y2)-(y3) can be carried out in the above sequence or simultaneously.

The preparation of unbleached, microfibrous non-woven chamois fabric (step y1) is effected using techniques well- known to experts in the field, for example according to what is described in EP-A-0584511, U.S. Pat. No. 3,716,614 and U.S. Pat. No. 3,531,368, EP-A-20030028443 and in the Italian patent ITMI20022685A, all in the name of the Applicant. These patents are therefore mentioned as representing an integrant base of this description for any reference of interest. More specifically, a fiber is first prepared in staple form, consisting of polyethylene terephthalate, polyethylene terephthalate dyeable with cationic dyes or polytrimethylene terephthalate microfibres, etc. having a denier value ranging from 0.01 to 0.4 deniers, preferably in the range of 0.08÷0.15 deniers, in a polystyrene matrix or a styrene copolymer or co-polyester or polyvinyl alcohol, etc. which acts as a “sheath”. Generally the fiber in staple form has the following characteristics: from 1.4 to 10 deniers and preferably from 2.5 to 6 deniers; length from 30 to 150 mm preferably in the range of 30÷100 mm; stretching ratio from 2/1 to 5/1; curlings from 4 to 15 per centimetre. The fiber in staple form can also contain 30÷90 parts by weight of polyethylene terephthalate, polyethylene terephthalate dyeable with cationic dyes or polytrimethylene terephthalate microfibres, etc., 10÷70 parts by weight of polystyrene matrix or a styrene copolymer or a co-polyester or polyvinyl alcohol, etc. and possibly different types of additives.

An unbleached felt is prepared with one or more of said fibres in staple form, which undergoes needling to form a needled felt having a suitable density in the order of 0.15÷0.35 g/cm³. The needled felt is then immersed in an aqueous solution of polyvinyl alcohol, for example from 10 to 30% by weight,. and, after drying, is immersed in a solvent capable of completely solubilizing the matrix. The resulting product is dried and represents the non-woven fabric of microfibres, to which an elastomeric matrix, preferably polyurethane, is applied, by immersion in a solution/dispersion.

The term polyurethane refers to a polymer consisting of flexible segments (soft segments) and rigid segments (hard segments).

The flexible segments can be polymeric chains based on the following polymers and/or copolymers and/or blends thereof, having a weight average molecular weight ranging from 500÷5,000, preferably from 600 to 2,000:
polyethers, such as, for example, derivatives of polyietramethylene glycol diol (PTMG), polyethylene glycol diol (PEG), polypropylene glycol diol (PPG);
polyesters, such as, for example, esters of adipic acid such as polyhexamethylene adipate diol (PHA), poly(3-methyl pentamethylene) adipate diol (PMPA) or polyneopentyl adipate diol (PNA); other polyesters can be produced by the opening of cyclic molecules, such as caprolactone (thus obtaining caprolactone diol, in short PCL);
polycarbonates, such as, for example, polyhexamethylene carbonate diol (PHC), polypentamethylene carbonate diol (PPMC), poly-(3-methyl-pentamethylene carbonate) diol(PMPC), polytetramethylene carbonate diol (PTMC), blends thereof and copolymers.

Polyesters formed by the copolymerization of the polyethers and polyesters mentioned above, can be used as flexible segments, as well as polyester-co-polycarbonates obtained by the copolymerization of polyesters and polycarbonates.

The polymers of the polyester, polycarbonate type and co-polymers of the polyester-polycarbonate type and of the polyester-polyether type having a number average molecular weight ranging from 500 to 5,000, preferably from 600 to 2000, containing groups of a hydrophilic nature, and/or with a negative charge, such as, for example, dimethyl propionic acid (DMPA) or functionalized sulphonic acids, can also be used as flexible segments; polyurethane dispersions can be obtained in this way.

The rigid segments refer to portions of the polymeric chains obtained from the reaction of an aromatic diisocyanate, such as, for example, methylene-bis-(4-phenylisocyanate) (MDI) or toluene diisocyanate (TDI) or an aliphatic or cyclo-aliphatic diisocyanate with a diamine or glycolic chain. It is well-known, in fact, that the completion of the polyurethane synthesis can be effected with diamines, thus obtaining polyurethane-ureas, or with glycols obtaining polyurethane.

Possible diamines which can be used as chain extenders in the production of polyurethane-ureas are, among aliphatic products, ethylene diamine (EDA), 1,3-cyclohexane diamine (1,3-CHDA), 1,4-cyclohexane diamine (1,4-CHDA) isophorondiamine (IPDA), 1,3-propylene diamine (1,3-PDA), and relative blends. Typical examples of aromatic diamines to be used as chain extenders are 3,3′-dichloro-4,4′-diamine diphenyl methane, methylene-bis(4-phenylamine) (MPA), 2,4-diamino-3,5-diethyltoluene; 2,4-diamino-3,5-di(methylthio) toluene. The above aliphatic and/or aromatic diamines can be added as such or developed in situ by reaction between the corresponding isocyanate and water. The chain extension in the polyurethane in the true sense, can also be obtained with diols such as ethylene glycol, tetramethylene glycol and relative blends. The chain extension can also be obtained through dicarboxylic acids such as malonic, succinic, adipic acids.

The above preparations of the various polyurethanes are well-known to experts in the field.

Returning to step (y1), if polymeric solutions are used, the impregnated product is squeezed through two rolls and coagulation in water is effected, for example at 20÷50° C. A coagulated sheet is obtained which is poured into hot water, for example at about 80° C., to extract the residual solvent and polyvinyl alcohol. In the case of polymeric dispersions, the impregnated product is squeezed through two rolls, vapour coagulation is then effected, either in an acidic aqueous solution or in dry heat.

The coagulated sheet is then dried, cut into sheets of 0.6÷1.5 mm which are subjected to polishing-to raise the surface pile.

The unbleached synthetic composite microfibrous non-woven fabric thus obtained at the end of the step (y1), is subjected to combined treatment of dyeing and contact with the UV stabilizer composition described above (steps y2 and y3 together) or, as an alternative, the fabric is first dyed (step y2) and then immersed (step y3) in an aqueous bath containing the UV stabilizers.

The whole material is then subjected to drying and thermo-setting.

As already mentioned, the present invention relates to the application of UV stabilizers according to the method described hereunder:

(i) Introduction of one or more UV stabilizers during the dyeing step. According to an embodiment of the present invention, the dyeing treatment and introduction of stabilizers is carried out in “circular” dyeing equipment, equipped with a Venturi nozzle, for example the equipment supplied by the company Hisaka Works Ltd. The dyeing cycle consists of a first dyeing step, in which the unbleached synthetic composite microfibrous non-woven fabric is put in contact with a mixture of dyes, one or more UV stabilizers selected from benzotriazoles, triazines and benzophenones in which at least one of the components belongs to the group of triazines, surface-active agents which disperse the dye and facilitate the passage to the fibre, pH conditions suitable for allowing the dye to penetrate inside the fibre, and dyeing auxiliaries. The maximum dyeing temperature, normally ranging from 10 to 140° C., is selected so as to bring the polymers forming the microfibre above their glass transition temperature, thus facilitating the diffusion of the dye and stabilizers in its interior.

If microfibres of polyethylene terephthalate and/or polytrimethylene terephthalate, etc. are used, the dyeing blend consists of dispersed dyes, preferably selected from the dispersed dyes of a non-azo type, whereas, when a microfibre of polyethylene terephthalate dyeable with cationic dyes is used, the dye blend consists of cationic dyes. If a mix of fibres consisting of polyethylene terephthalate and/or polytrimethylene terephthalate and polyethylene terephthalate dyeable with cationic dyes, is used, the blend of dyes consists of dispersed dyes and cationic dyes.

The quantity of triazine dye used alone or in a blend with benzotriazole and/or benzophenone stabilizers, is suitably maintained with percentages of active principle ranging from 0.1 to 5% by weight with respect to the microfibrous non-woven fabric. Stabilizers can be added directly to the dyeing bath, or, preferably, pre-dispersed in a liquid vehicle containing from 10 to 40% by weight of active substance.

In practice, the microfibrous non-woven fabric is circulated inside the dyeing equipment for 1 hour or so, at the highest dyeing temperature and, subsequently, subjected to cleaning treatment with sodium hydrosulphite in a basic environment.

In addition to the dyeing treatment, it is possible to effect finishing treatment to confer other specific properties to the product, such as a softer feel. It is also possible to process the end product under heat, up to 250° C., for an amount of time strictly necessary for effecting, for example, coupling to other substrates, printing, embossing, lamination, injection printing, thermosetting.

(ii) Introduction of UV stabilizers after dyeing by padding; according to the process of the present invention, the introduction of one or more stabilizers selected from triazines, benzotriazoles, and benzophenones, at least one of the components belonging to the group of triazines is carried out on a microfibrous non-woven fabric dyed by immersion at room temperature in an aqueous solution containing the above stabilizers in a weight percentage ranging from 0.01 to 25%, different kinds of additives, pH regulators, bactericides, fungicides, etc . . .

The squeezing level adopted is between 20 and 70%. After removal of the aqueous solution, the material is dried at a temperature of 95-180° C. preferably at about 140° C.

The product thus obtained has excellent characteristics with respect to appearance, feel, lightness, velour and absence of tone differences between velour and background. More than anything else, the material obtained has a particularly high light resistance with respect to similar products of the known art, so that, for example, after exposure to the methods DIN 75 202 (3 fakra), D 47 1431 (150 hours), SAE J1880 225.6 KJ/m², the colour difference is not less than ¾ of the grey scale. This characteristic makes the material particularly suitable for applications in the car industry, as car upholstery or similar uses. The evaluation of-the colour fastness to light is effected by evaluating the colour variation before and after exposure, using the grey scale ISO 105A02.

In the light exposure methods, the irradiating spectrum can also include radiations having wave-lengths of 270 to 700 nm; as known, UV radiations having a wave-length of 270 and 400 nm prove to be the most dangerous for colour fastness to light.

The following experimental examples are illustrative and non-limiting of the scope of the present invention:

### EXAMPLES

The following UV resistant products were used both singly and in a combination thereof:

1. Triazine derivative (produced by Ciba and called Cibafast® P):λₘₐₓ=275 nm.

2. Benzotriazole derivative (produced by Ciba and called Cibafast® PEX):λₘₐₓ=352 nm.

3. Benzophenone derivative (produced by Clariant and called Fadex® ECS):λₘₐₓ=288 nm.

Examples 1 to 9 refer to the treatment of a microfibrous non-woven fabric consisting of PET alone; whereas examples 10 to 14 refer to the treatment of a microfibrous non-woven fabric consisting of blends of polyethylene terephthalate and polyethylene terephthalate dyeable with cationic dyes.

### Example 1

### PET Microfibrous Non-Woven Fabric without UV Stabilizers

A fibre in staple form is prepared, made of polyethylene terephthalate microfibres (0.10÷0.011 deniers) in a polystyrene matrix, having the following characteristics: 3.8 deniers, length 51 mm, 5 curlings/cm, stretching ratio 2.5/1. In particular, the fibre is made up of 57 parts by weight of polyethylene terephthalate microfibre, 43 parts by weight of polystyrene matrix. In a sectional view, the fibre reveals the presence of 16 microfibres of polyethylene terephthalate englobed in the polystyrene matrix. An unbleached felt is prepared with the fibre in staple form, subjected to needling to form a needled felt having a density of 0.185 g/cm³. The needled felt is immersed in a 20% by weight aqueous solution of polyvinyl alcohol and is then subjected to drying. The needled felt thus treated is subsequently immersed in trichloroethylene until complete dissolution of the polystyrene matrix of the fibres, with the consequent formation of a non-woven fabric of polyethylene terephthalate microfibres. The non-woven fabric produced is then dried and an intermediate product called felt is obtained.

The felt is immersed in the polyurethane elastomeric solution and the non-woven fabric thus impregnated is first squeezed by passing it through a pair of rolls and subsequently immersed for 1 hour in a water bath maintaining the temperature at 40° C. A coagulated sheet is thus obtained which is passed into a water bath heated to 80° C., to extract the residual solvent and polyvinyl alcohol. After drying, a composite microfibrous sheet is obtained which is cut into sheets having a thickness of 1 mm, which are subjected to polishing to raise the surface pile. A synthetic unbleached non-woven fabric is obtained having a thickness of 0.8 mm, which is subjected to dyeing in “JET” equipment, equipped with a “Venturi tube”. In particular, the synthetic unbleached non-woven fabric is passed through the “Venturi tube” for 1 hour, at 125° C., in an aqueous dyeing bath containing the following dispersed dyes:
dispersed Red dye (anthraquinone type) 2.5% by weight
dispersed Blue dye (anthraquinone type) 28% by weight
dispersed Orange dye (amino-ketone type) 10% by weight

After dyeing, a dyed microfibrous non-woven fabric is obtained which, after further treatment under reducing conditions with sodium hydrosulphite in an alkaline environment to eliminate the excess dye, is subjected to evaluation tests of the colour resistance to dry and wet rubbing (AATCC 8-2001), to soap washing (AATCC 61-2001), to dry washing and to light (SAEJ -225 KJ).

The evaluations, shown in the following table, relating to the dyed microfibrous non-woven fabric, were effected as follows:
a) as far as the colour discharge on a test sample is concerned (multifibre felt for washings and cloth for the rubbing) the soiling is evaluated by comparison with the grey scale ISO 105A03;
b) as far as the shade exchange of the sample, before and after the test, is concerned, the grey scale ISO 105A02 is used.

The evaluation is effected by comparing the shade exchange or dirt level with the codified contrasts by means of the appropriate grey scale; an evaluation of 5 corresponds to no change in shade/colour transfer, whereas a value of 1 corresponds to the maximum contrast on the grey scale used.

| TEST | Evaluation |
|---|---|
| Wet rubbing AATCC 8-2001 (colour discharge) | 4 |
| Dry rubbing AATCC 8-2001 (colour discharge) | 4/5 |
| Washing with soap AATCC 61-2001 (colour change) | 5 |
| Washing with soap AATCC 61-2001 (colour discharge) | 4/5 |
| Dry washing (shade exchange) | 5 |
| Dry washing (colour discharge) | 4/5 |
| Light fastness, SAE J 1885 225 KJ (shade change) | 2/3 |

### Example 2

### 2% Benzotriazole

The same procedure is adopted as in example 1, adding a substituted benzotriazole to the dyeing bath, known in the market as Cibafast® PEX of the company Ciba, in an active principle percentage of 2% by weight with respect to the microfibrous non-woven fabric. This additive is added to the dyeing bath pre-dispersed in a liquid vehicle. A dyed, microfibrous non-woven fabric is obtained having a light fastness value of 3, determined as described in example 1 and with the other characteristics similar to those in said example 1.

### Example 3

### 2% Benzophenone

The same procedure is adopted as in example 1, adding a substituted benzophenone to the dyeing bath, known on the market as Fadex® ECS of the company Clariant, in an active principle percentage of 2% by weight with respect to the microfibrous non-woven fabric. This additive is added to the dyeing bath pre-dispersed in a liquid vehicle. A dyed, microfibrous non-woven fabric is obtained having a light fastness value of 3, determined as described in example 1 and with the other characteristics similar to those in said example 1.

### Example 4

### 2% Triazine

The same procedure is adopted as in example 1, adding a substituted triazine to the dyeing bath, known on the market as Cibafast® P of the company Ciba, in an active principle percentage of 2% by weight with respect to the microfibrous non-woven fabric. This additive is added to the dyeing bath pre-dispersed in a liquid vehicle.

A dyed, microfibrous non-woven fabric is obtained having a light fastness value of ¾, determined as described in example 1 and with the other characteristics similar to those in said example 1.

### Example 5

### 1% Benzotriazole and 1% Benzophenone

The same procedure is adopted as in example 1, adding a blend of UV stabilizers to the dyeing bath, consisting of Cibafast® PEX in an active principle percentage of 1% by weight with respect to the microfibrous non-woven fabric, and Fadex® ECS in an active principle percentage of 1% by weight with respect to the microfibrous non-woven fabric. These additives are added to the dyeing bath pre-dispersed in a liquid vehicle. A dyed, microfibrous non-woven fabric is obtained having a light fastness value of 3, determined as described in example 1 and with the other characteristics similar to those in said example 1.

### Example 6

### 1% Triazine and 1% Benzophenone

The same procedure is adopted as in example 1, adding a blend of UV stabilizers to the dyeing bath, consisting of Cibafast® P in an active principle percentage of 1% by weight with respect to the microfibrous non-woven fabric, and Fadex® ECS in an active principle percentage of 1% by weight with respect to the microfibrous non-woven fabric. These additives are added to the dyeing bath pre-dispersed in a liquid vehicle. A dyed, microfibrous non-woven fabric is obtained having a light fastness value of ¾, determined as described in example 1 and with the other characteristics similar to those in said example 1.

### Example 7

### 1% Triazine and 1% Benzotriazole

The same procedure is adopted as in example 1, adding a blend of UV stabilizers to the dyeing bath, consisting of Cibafast® P in an active principle percentage of 1% by weight with respect to the microfibrous non-woven fabric, and Cibafast® PEX in an active principle percentage of 1% by weight with respect to the microfibrous non-woven fabric. These additives are added to the dyeing bath pre-dispersed in a liquid vehicle. A dyed, microfibrous non-woven fabric is obtained having a light fastness value of ¾, determined as described in example 1 and with the other characteristics similar to those in said example 1.

### Example 8

### 0.66% Triazine, 0.66% Benzotriazole and 0.66% Benzophenone

The same procedure is adopted as in example 1, adding a blend of UV stabilizers to the dyeing bath, consisting of Cibafast® P in an active principle percentage of 0.66% by weight with respect to the microfibrous non-woven fabric, Cibafast® PEX in an active principle percentage of 0.66% by weight with respect to the microfibrous non-woven fabric, and Fadex® ECS in an active principle percentage of 0.66% by weight with respect to the microfibrous non-woven fabric. These additives are added to the dyeing bath pre-dispersed in a liquid vehicle.

A dyed, microfibrous non-woven fabric is obtained having a light fastness value of 4, determined as described in example 1 and with the other characteristics similar to those in said example 1.

### Example 9

### 1% Triazine, 1% Benzotriazole and 1% Benzophenone by Padding

The same procedure is adopted as in example 1, but the already dyed microfibrous non-woven fabric is treated by dipping it into an aqueous solution (padding treatment) containing:
substituted triazine commercially known as Cibafast® P in an active principle percentage of 1% by weight;
substituted benzotriazole commercially known as Cibafast® PEX in an active principle percentage of 1% by weight;
substituted benzophenone commercially known as Fadex® ECS in an active principle percentage of 1% by weight.

The retention level adopted on the wet product was 117%. After removal from the water solution, the material is dried at a temperature of 100° C. for about 3 minutes.

A dyed, microfibrous non-woven fabric is obtained having a light fastness value of 4, determined as described in example 1 and with the other characteristics similar to those in said example 1.

### Example 10

### PET and PET dyeable with cationic dyes microfibrous non-woven fabric, without UV stabilizers.

This example is similar to example 1, with the exception of the preparation of the unbleached felt. In addition to the fibre in staple form of example 1, a fibre in staple form is prepared consisting of PET dyeable with cationic dyes microfibres in a polystyrene matrix, having the following characteristics:

1. Deniers: 3.8 den

2. Length: 51 mm

3. Curlings: about 4-5/cm.

The fiber is made up of 57 parts by weight of PET dyeable with cationic dyes and 43 parts by weight of polystyrene.

The two types of staple obtained are homogeneously mixed with each other in the most appropriate proportions for obtaining the desired dyeing effect, characterized by a Melange aspect defined as an alternation of colours and/or intensity obtained through the close mixing of fibres having a different dyeability. The PET content is normally within the range of 85-40%, the content of PET dyeable with cationic dyes commonly ranges between 15-60%.

An unbleached felt is prepared from the blend of the two fibres in staple form, and is subjected to needling to form a needled felt having a density of 0.185 g/cm³. The needled felt is dipped into a 20% by weight aqueous solution of polyvinyl alcohol and then undergoes drying. The needled felt thus treated is subsequently dipped into trichloro ethylene until the complete dissolution of the polystyrene matrix of the fibres, with the consequent formation of a non-woven fabric of PET and PET dyeable with cationic dyes. The non-woven fabric thus formed is then dried, and an intermediate product called felt is obtained. The felt, as prepared in example 1, is immersed in the solution of polyurethane elastomer and the impregnated non-woven fabric is first squeezed by passing it between two rolls and subsequently dipped for 1 hour in a water bath at a temperature of 40° C. A coagulated sheet is obtained which is passed into a water bath at a temperature of 80° C., to extract the residual solvent and the polyvinyl alcohol. A composite microfibrous sheet is obtained after drying which is cut into sheets having a thickness of 1 mm, and the sheets are then subjected to polishing to raise the surface pile. An unbleached, synthetic non-woven fabric is obtained having a thickness of 0.8 mm, which is subjected to dyeing in “JET” apparatus equipped with a “Venturi Tube”. In particular, the unbleached, synthetic non-woven fabric is passed through the “Venturi Tube” for one hour, operating at 125° C. in an aqueous dyeing bath containing the following dispersed and cationic dyes:

| | | |
|---|---|---|
| Cationic dyes of the | Blue cationic (%) | 0.335 |
| dispersed type | Red cationic (%) | 0.153 |
| | Yellow cationic (%) | 0.278 |
| Dispersed dyes | Orange dispersed (%) | 0.148 |
| | Yellow dispersed (%) | 0.038 |
| | Pink dispersed (%) | 0.020 |
| | Turquoise dispersed (%) | 0.022 |
| | Violet dispersed (%) | 0.033 |

At the end of dyeing, a dyed microfibrous non-woven fabric is obtained which, after further treatment under reducing conditions with sodium hydrosulphite in an alkaline environment to eliminate the excess dye, is subjected to a test for evaluating the colour resistance to dry and wet rubbing (AATCC 8-2001), to soap washing (AATCC 61-2001), to dry washing and to the light (SAEJ-225 KJ).

The evaluations shown in the following table, relating to the dyed microfibrous non-woven fabrics were effected as follows:
a) as far as the colour discharge on a test sample is concerned (multifibre felt for washings and cloth for rubbings) the soiling is evaluated by comparison with the grey scale ISO 105A03;
b) with respect to the shade exchange of the sample, before and after the test, the grey scale ISO 105A02 is used.

The evaluation is effected by comparing the shade exchange or the dirt level with the codified contrasts by means of the appropriate grey scale; an evaluation of 5 corresponds to no change in shade/colour transfer, whereas a value of 1 corresponds to the maximum contrast on the grey scale used.

| TEST | Evaluation |
|---|---|
| Wet rubbing AATCC 8-2001 (colour discharge) | 4 |
| Dry rubbing AATCC 8-2001 (colour discharge) | 4 |
| Washing with soap AATCC 61-2001 (colour change) | 4/5 |
| Washing with soap AATCC 61-2001 (colour discharge) | 4 |
| Dry washing (shade exchange) | 5 |
| Dry washing (colour discharge) | 4/5 |
| Light fastness, DIN 75 202, 3 fakra (shade change) | 2/3 |

### Example 11

### 1% Benzotriazole and 1% Benzophenone

The same procedure is adopted as in example 10, adding to the dyeing bath a blend of UV stabilizers consisting of Cibafast5 PEX in an active principle percentage of 1% by weight with respect to the microfibrous non-woven fabric and Fadex® ECS in an active principle percentage of 1% by weight with respect to the microfibrous non-woven fabric.

These additives are added to the dyeing bath pre-dispersed in a liquid vehicle.

A dyed, microfibrous non-woven fabric is obtained having a light fastness value of 3, determined as described in example 10 and with the other characteristics similar to those in said example 10.

### Example 12

### 1.6% Benzotriazole and 0.4% Triazine

The same procedure is adopted as in example 10, adding to the dyeing bath a blend of UV stabilizers consisting of Cibafast® PEX in an active principle percentage of 1.6% by weight with respect to the microfibrous non-woven fabric and Cibafast® P in an active principle percentage of 0.4% by weight with respect to the microfibrous non-woven fabric.

These additives are added to the dyeing bath pre-dispersed in a liquid vehicle. A dyed, microfibrous non-woven fabric is obtained having a light fastness value of 3, determined as described in example 10 and with the other characteristics similar to those in said example 10.

### Example 13

### 1% Benzotriazole and 1% Triazine

The same procedure is adopted as in example 10, adding to the dyeing bath a blend of UV stabilizers consisting of Cibafast® PEX in an active principle percentage of 1% by weight with respect to the microfibrous non-woven fabric and Cibafast® P in an active principle percentage of 1% by weight with respect to the microfibrous non-woven fabric.

These additives are added to the dyeing bath pre-dispersed in a liquid vehicle.

A dyed, microfibrous non-woven fabric is obtained having a light fastness value of ¾, determined as described in example 10 and with the other characteristics similar to those in said example 10.

### Example 14

### 0.4% Benzotriazole and 1.6% Triazine

The same procedure is adopted as in example 10, adding to the dyeing bath a blend of UV stabilizers consisting of Cibafast® PEX in an active principle percentage of 0.4% by weight with respect to the microfibrous non-woven fabric and Cibafast® P in an active principle percentage of 1.6% by weight with respect to the microfibrous non-woven fabric.

These additives are added to the dyeing bath pre-dispersed in a liquid vehicle.

A dyed, microfibrous non-woven fabric is obtained having a light fastness value of ¾, determined as described in example 10 and with the other characteristics similar to those in said example 10.

Comment to the Examples

By examining the results shown in the examples, a clear improvement in the colour fastness to light is observed, thanks to the introduction of the triazine derivative used alone or mixed with compounds belonging to other groups of UV stabilizers on the microfibrous non-woven fabric. Its physico-chemical property of efficiently absorbing more energetic radiations (i.e. at lower wave-lengths) in the ultraviolet range with respect to the other stabilizers used, allows a better protection of the dyed product to be obtained from those degradation phenomena due to a frequent and/or prolonged irradiation. In particular, the UV action of the binary blends of stabilizers applied on the microfibrous non-woven fabric during the dyeing phase, and of the ternary blend during the finishing phase is enhanced when the amount of active principle of the triazine derivative is higher than 30% by weight with respect to the total amount of the blend. A synthesis of the results is shown in the following table, wherein the letter “c” in the examples means “comparative example”.

The acronym PET means polyethylene terephthalate whereas the acronym PET-CD means polyethylene terephthalate dyeable with cationic dyes.

| Ex. | Substrate | Application | Stabilizer | % | Evaluation |
|---|---|---|---|---|---|
| 1c | PET | — | — | — | 2/3 |
| 2c | PET | DYEING | Benzotriazole | 2 | 3 |
| 3c | PET | DYEING | Benzophenone | 2 | 3 |
| 4 | PET | DYEING | Triazine | 2 | 3/4 |
| 5c | PET | DYEING | Benzotriazole | 1 | 3 |
| | | | Benzophenone | 1 | |
| 6 | PET | DYEING | Triazine | 1 | 3/4 |
| | | | Benzotriazole | 1 | |
| 7 | PET | DYEING | Triazine | 1 | 3/4 |
| | | | Benzotriazole | 1 | |
| 8 | PET | DYEING | Triazine | 0.66 | 4 |
| | | | Benzotriazole | 0.66 | |
| | | | Benzophenone | 0.66 | |
| 9 | PET | FINISHING | Triazine | 1 | 4 |
| | | | Benzotriazole | 1 | |
| | | | Benzophenone | 1 | |
| 10c | PET/PET-CD | — | — | — | 2/3 |
| 11c | PET/PET-CD | DYEING | Benzotriazole | 1 | 3 |
| | | | Benzophenone | 1 | |
| 12c | PET/PET-CD | DYEING | Triazine | 0.4 | 3 |
| | | | Benzotriazole | 1.6 | |
| 13 | PET/PET-CD | DYEING | Triazine | 1 | 3/4 |
| | | | Benzotriazole | 1 | |
| 14 | PET/PET-CD | DYEING | Triazine | 1.6 | 3/4 |
| | | | Benzotriazole | 0.4 | |

What is claimed is:

1. A microfibrous non-woven chamois fabric, comprising:
microfibres selected from polyester microfibres;
an elastomeric matrix; and
a composition of UV stabilizers, wherein at least one of the UV stabilizers has a maximum absorbance at wavelengths ranging from 270 to 285 nm.

2. The non-woven fabric according to claim 1, wherein the elastomeric matrix is selected from polyurethane, urea-polyurethane, and blends thereof.

3. The non-woven fabric according to claim 1, wherein the polyester is selected from polyethylene terephthalate, polymethylene terephthalate, polyethylene terephthalate dyeable with cationic dyes, and blends thereof.

4. The non-woven fabric according to claim 1, wherein the polyester is dyed with a mix of dispersed dyes, at least one of the dispersed dyes comprising a dispersed anthraquinone dye.

5. The non-woven fabric according to claim 1, wherein the light fastness is higher than 3.

6. The non-woven fabric according to claim 1, wherein the UV stabilizer having a maximum absorbance at wavelengths ranging from 270 to 285 nm is selected from triazines and relative derivatives.

7. The non-woven fabric according to claim 1, wherein the composition of UV stabilizers consists of compounds having a maximum absorbance from 270 to 285 nm.

8. The non-woven fabric according to claim 1, wherein the composition of UV stabilizers consists of:
one or more compounds having a maximum absorbance of 270 to 285 nm; and
one or more compounds selected from benzophenones, benzotriazoles and blends thereof.

9. The non-woven fabric according to claim 8, wherein the composition of UV stabilizers consists of at least 30% by weight of one or more compounds having a maximum absorbance of 270 to 285 nm.

10. The non-woven fabric according to claim 1, wherein the composition of UV stabilizers is present in an amount of 0.5 to 5% by weight with respect to the microfibrous non-woven fabric.

11. The non-woven fabric according to claim 10, wherein the composition of UV stabilizers is present in an amount of 1.5 to 3% by weight with respect to the microfibrous non-woven fabric.

12. The non-woven fabric according to claim 3, wherein the polyester is polyethylene terephthalate.

13. The non-woven fabric according to claim 12, wherein it has a light fastness value greater than 3, a value of resistance to wet rubbing greater than 3, and an L value less than 35.

14. The non-woven fabric according to claim 3, wherein the polyester consists of a blend of polyethylene terephthalate and polyethylene terephthalate dyeable with cationic dyes.

15. The non-woven fabric according to claim 14, wherein it has a light fastness value greater than 3, a value of resistance to wet rubbing greater than 3, and an L value of between 45 and 75.

16. A process for the preparation of the microfibrous non-woven chamois fabric of claim 1, the process comprising:
preparing an unbleached microfibrous non-woven chamois fabric;
dyeing the unbleached microfibrous non-woven chamois fabric to obtain a dyed product; and
treating the dyed product with a composition of UV stabilizers, at least one of the UV stabilizers having a maximum absorption at wavelengths from 270 to 285 nm.

17. The process according to claim 16, wherein the dying and treating steps are effected contemporaneously.
